(19) United States
(12) Patent Application Publication
(10) Pub. No.: US 2011/0128971 A1
(43) Pub. Date: Jun. 2, 2011

(54) SEMICONDUCTOR DEVICE AND SIGNAL TRANSMISSION METHOD THEREOF

(76) Inventor: Chang-Ho Do, Gyeonggi-do (KR)

(21) Appl. No.: 12/649,004

(22) Filed: Dec. 29, 2009

(30) Foreign Application Priority Data
Nov. 30, 2009 (KR) 10-2009-0117447

(51) Int. Cl. H04J 3/00

(52) U.S. Cl. 370/464

(57) ABSTRACT

A semiconductor device having a plurality of transmission lines for transmitting a plurality of signals includes: a first transmission line configured to transmit a first signal while maintaining a same phase of the first signal during an entire transmission duration; and a second transmission line positioned adjacent to the first transmission line and configured to transmit a second signal while inverting a phase of the second signal during a first duration of the entire transmission duration.

### CROSS-REFERENCE TO RELATED APPLICATIONS

The present application claims priority of Korean Patent Application No. 10-2009-0117447, filed on Nov. 30, 2009, which is incorporated herein by reference in its entirety.

### BACKGROUND OF THE INVENTION

Embodiments of the present invention relate to a technology for designing a semiconductor integrated circuit, and more particularly, to a semiconductor device and a signal transmitting method thereof.

In this specification, a semiconductor memory device is taken as an example to describe the technology of embodiments of the present invention.

Generally, diverse transmission lines are arrayed in a semiconductor memory device and signals are simultaneously transmitted through the diverse transmission lines. For example, diverse transmission lines are arrayed to transfer signals, such as a row address signal for selecting a word line of a cell array, a column address signal for selecting a bit line of a cell array of a cell array, and a data signal.

FIG. 1 is a schematic diagram illustrating internal transmission lines of a conventional semiconductor memory device. Herein, it is assumed that the semiconductor memory device includes two transmission lines for the sake of convenience in description.

Referring to FIG. 1, the semiconductor memory device 10 includes a first transmitter 11A and a second transmitter 11B for respectively transforming the signal levels of a first signal IN1 and a second signal IN2 and for transmitting the transformed signals.

The semiconductor memory device also includes a first receiver 12A and a second receiver 12B respectively in correspondence with the first and second transmitters 11A and 11B. The first and second receivers 12A and 12B receive the first and second signals IN1 and IN2 respectively transmitted by the first and second transmitters 11A and 11B, transform the first and second signals IN1 and IN2 to their original signal levels and respectively output a first output signal OUT1 and a second output signal OUT2.

A first transmission line 13A and a second transmission line 13B are arrayed between the first transmitter 11A and the second transmitter 11B to respectively transfer the first and second signals IN1 and IN2.

Since the first and second transmission lines 13A and 1313 are typically formed of metal and there is a dielectric substance, e.g., air, between the first transmission line 13A and the second transmission line 13B, a parasitic capacitance C is formed between the first transmission line 13A and the second transmission line 13B.

Accordingly, when the first and second signals IN1 and IN2 are transmitted through the first and second transmission lines 13A and 13B, they interfere with each other. This unnecessary coupling is referred to as crosstalk noise. In other words, the first and second signals IN1 and IN2 have a signal delay caused by an effective capacitance existing between the first transmission line 13A and the second transmission line 13B. The signal delay characteristics of the first and second transmission lines 13A and 13B are different according to the phase relationship between the first signal IN1 and the second signal IN2. The difference is described hereafter with reference to FIGS. 2A and 2B.

FIGS. 2A and 2B are timing diagrams when the first and second signals IN1 and IN2 transmitted through the first and second transmission lines of FIG. 1 have the same phase. FIGS. 2C and 2D are timing diagrams when the first and second signals IN1 and IN2 transmitted through the internal first and second transmission lines of FIG. 1 have opposite phases. FIG. 2E is a timing diagram obtained by overlapping the timing diagrams of FIGS. 2A to 2D.

First, as illustrated in FIGS. 2A and 2B, when the first and second signals IN1 and IN2 having the same phase are inputted through the first and second transmitters 11A and 11B, the first and second output signals OUT1 and OUT2 outputted through the first and second receivers 12A and 12B have a signal delay of ‘A.’ The signal delay originates from the effective capacitance caused by the parasitic capacitance C because the first and second signals IN1 and IN2 inputted to the first and second transmitters 11A and 11B have the same phase.

Referring to FIGS. 2C and 2D, when the first and second signals IN1 and IN2 have opposite phases and are inputted to the first and second transmitters 11A and 11B, the first and second output signals OUT1 and OUT2 outputted by the first and second receivers 12A and 12B have a signal delay of ‘B.’ The signal delay appears longer than the signal delay illustrated in FIGS. 2A and 2B (B>A). The first and second signals IN1 and IN2 inputted to the first and second transmitters 11A and 11B have a different phase, and therefore, the effective capacitance caused by the parasitic capacitance C is higher than the effective capacitance when the first and second signals IN1 and IN2 inputted to the first and second transmitters 11A and 11B have the same phase.

As described above, the phenomenon that the effective capacitances existing in the first and second transmission lines 13A and 13B become different according to the phase relationship between the first signal IN1 and the second signal IN2, that is, whether the first and second signals IN1 and IN2 have the same phase or the opposite phase is widely known as the Miller Effect.

Therefore, as shown in FIG. 2E, the first and second output signals OUT1 and OUT2 outputted by the first and second receivers 12A and 12B have a different signal delay A or B according to the phase relationship of the first and second output signals OUT1 and OUT2. In short, when the first and second signals IN1 and IN2 have the same phase, the first and second signals IN1 and IN2 are transmitted rapidly. When the first and second signals IN1 and IN2 have opposite phases, the first and second signals IN1 and IN2 are transmitted relatively slowly. In this case, the output skew of the first and second receivers 12A and 12B, i.e., the delay time difference D, becomes long and this makes the size of a valid window small, which restricts a high frequency operation.

In order to resolve the problems, conventional technologies suggest disposing a shielding line between the first transmission line 13A and the second transmission line 13B, or disposing another transmission line that is not driven at the same moment between the first transmission line 13A and the second transmission line 13B to thereby reduce crosstalk noise. In particular, U.S. Pat. No. 6,828,852 discloses a technology for arranging a shielding line along with a signal transmission line in order to reduce signal delay caused by crosstalk noise originating from a parasitic capacitance between adjacent transmission lines.

However, as the demands for high-capacity semiconductor memory devices increase and semiconductor memory devices are required to process a high amount of data per unit time, the number of internal transmission lines are increasing rapidly. For example, the number of transmission lines in a Dynamic Random Access Memory (DRAM) has increased to almost 8 times as many as those in a Double Data Rate 3 Synchronous DRAM (DDR3 SDRAM). If all of the transmission lines exposed to the crosstalk noise are to be shielded, the increase in the number of shielding lines leads to an increase in the volume of a semiconductor memory device.

Furthermore, the increase in the volume of a semiconductor memory device not only has a great influence on price competitiveness when it is produced in great quantities but also reduces the competitiveness against products of the same kind.

### SUMMARY OF THE INVENTION

An embodiment of the present invention is directed to a semiconductor device with minimized volume and crosstalk noise caused when a plurality of signals are transmitted, and a signal transmission method thereof.

In accordance with an embodiment of the present invention, a semiconductor device having a plurality of transmission lines for transmitting a plurality of signals includes: a first transmission line configured to transmit a first signal while maintaining a phase of the first signal the same for an entire transmission duration; and a second transmission line positioned adjacent to the first transmission line and configured to transmit a second signal while inverting a phase of the second signal for a first duration of the entire transmission duration.

In accordance with another embodiment of the present invention, a semiconductor device having a plurality of transmission lines for transmitting a plurality of signals includes: a first transmission line configured to transmit a first signal while maintaining a phase of the first signal the same for an entire transmission duration; and a second transmission line positioned adjacent to the first transmission line and configured to transmit a second signal; a signal phase inverter added between portions of the second transmission line having a first transmission duration and a second transmission duration and configured to invert a phase of the second signal, the second signal respectively having opposite phases in the portions of the second transmission line having the first transmission duration and the second transmission duration.

In accordance with yet another embodiment of the present invention, a semiconductor device having a plurality of transmission lines for transmitting a plurality of signals includes: a first transmission line configured to transmit a first signal; a first repeater added to the first transmission line and including an even-number of inverters; a second transmission line configured to transmit a second signal; and a second repeater added to the second transmission line and including an odd-number of inverters.

In accordance with still another embodiment of the present invention, a method of transmitting a signal in a semiconductor device which respectively transmits a first signal and a second signal through a first transmission line and a second transmission line, arrayed adjacent to each other, includes: transmitting the first signal and the second signal to have a first phase relationship in a portion of the first transmission line and the second transmission line having a first transmission duration; and transmitting the first signal and the second signal to have a second phase relationship in a portion of the first transmission line and the second transmission line having a second transmission duration, the second phase relationship being opposite to the first phase relationship.

### BRIEF DESCRIPTION OF THE DRAWINGS

FIG. 1 is a schematic diagram illustrating internal transmission lines of a conventional semiconductor memory device.

FIGS. 2A and 2B are timing diagrams when the signals transmitted through the internal transmission lines of FIG. 1 have the same phase.

FIGS. 2C and 2D are timing diagrams when the signals transmitted through the internal transmission lines of FIG. 1 have an opposite phase.

FIG. 2E is a timing diagram obtained by overlapping the timing diagrams of FIGS. 2A to 2D.

FIG. 3 is a schematic diagram showing an internal structure of a semiconductor device in accordance with a first embodiment of the present invention.

FIG. 4 is a timing diagram describing a signal transmitting method of the semiconductor device in accordance with the first embodiment of the present invention.

FIG. 5 is a schematic diagram illustrating an internal structure of an extended form of the semiconductor device shown in FIG. 3.

FIG. 6 is a schematic diagram illustrating an internal structure of a semiconductor device shown in accordance with a second embodiment of the present invention.

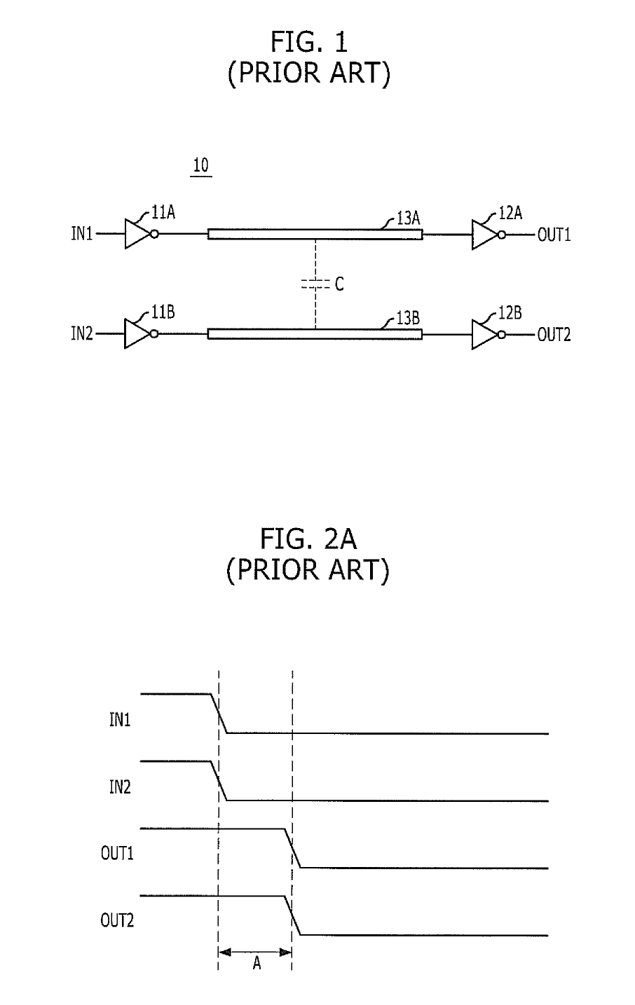

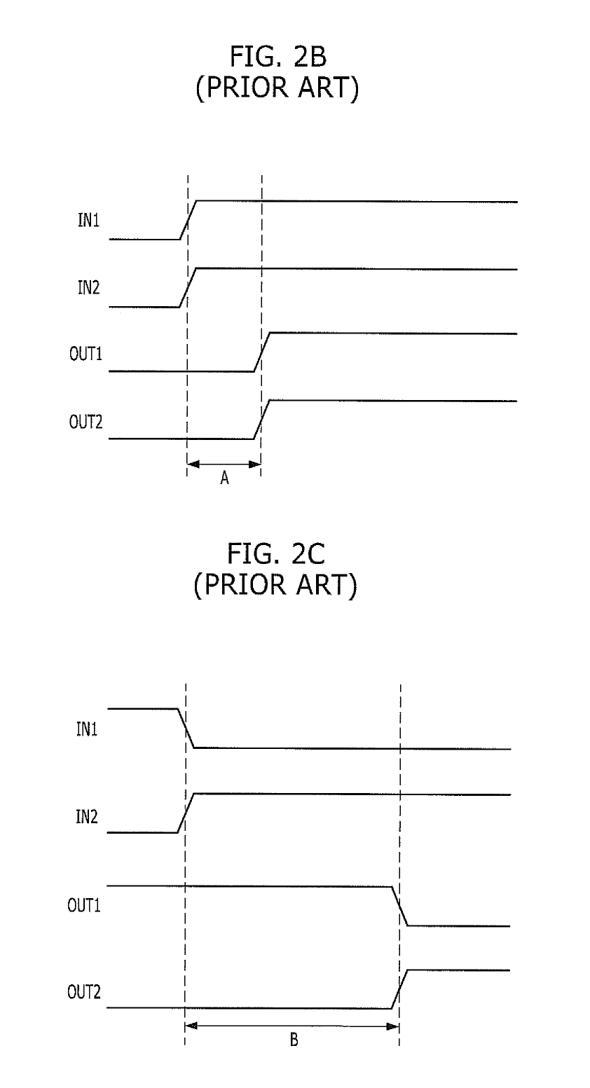

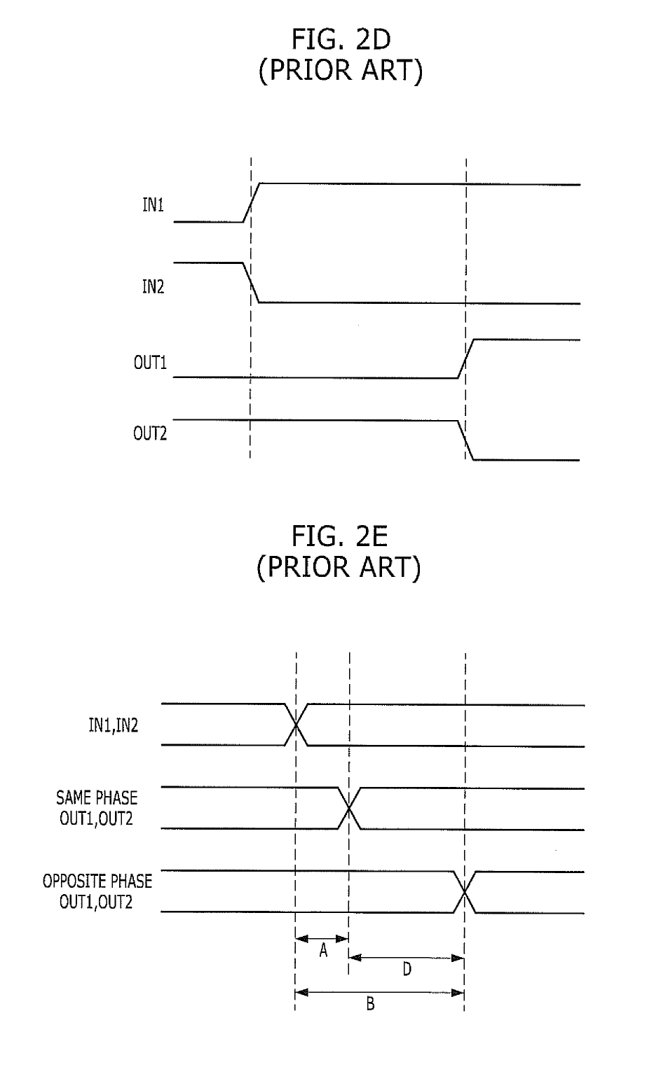

### DESCRIPTION OF THE INVENTION

Exemplary embodiments of the present invention are described below in more detail with reference to the accompanying drawings. The present invention may, however, be embodied in different forms and should not be constructed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various drawing figures and embodiments of the present invention.

The drawings are not necessarily to scale and in some instances, proportions may have been exaggerated in order to clearly illustrate features of the embodiments.

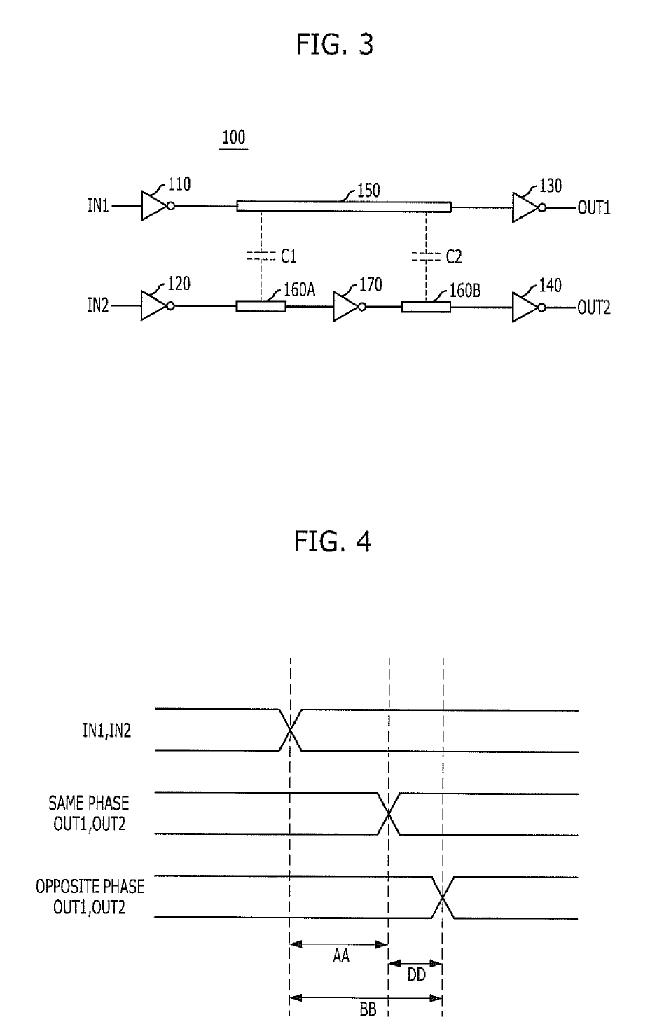

FIG. 3 is a schematic diagram showing an internal structure of a semiconductor device in accordance with a first embodiment of the present invention. Referring to FIG. 3, the semiconductor device includes a first transmitter 110 and a second transmitter 120 for transforming the signal levels of a first signal IN1 and a second signal IN2 to a predetermined level and for transmitting the level-transformed signals. The first and second signals IN1 and IN2 are an example of a plurality of signals that are simultaneously activated. For example, the first and second signals IN1 and IN2 may be a data signal, a column address signal, and a low address signal.

The semiconductor device also includes a first receiver 130 and a second receiver 140 which respectively correspond one-to-one to the first transmitter 110 and the second transmitter 120. The first and second receivers 130 and 140 receive the first and second signals IN1 and IN2, transmitted by the first and second transmitters 110 and 120, and transform the first and second signals IN1 and IN2 to their original signal levels to produce and output a first output signal OUT1 and a second output signal OUT2.

A first transmission line 150 and second transmission lines 160A and 1608 are positioned adjacent to each other between the first and second transmitters 110 and 120 and the first and second receivers 130 and 140 in order to respectively transmit the first and second signals IN1 and IN2. The first transmission line 150 maintains the same phase of the first signal IN1 during first and second transmission durations of the first transmission line 150 when the first signal IN1 is transmitted. On the other hand, the second transmission lines 160A and 160B transmit the second signal IN2 to have an opposite phase in the second transmission line 160A having the first transmission duration as compared to the second transmission line 160B having the second transmission duration when the second signal IN2 is transmitted. The first and second transmission durations are divided based on a signal phase inverter 170, which is described later, from among the entire transmission durations of the first and second signals IN1 and IN2 when the first and second signals IN1 and IN2 are transmitted through the first and second transmission lines 150, 160A and 1608.

To this end, the signal phase inverter 170 is positioned at the central part of the second transmission lines 160A and 160B to invert the phase of the second signal IN2. In other words, the signal phase inverter 170 performs an operation for making the first and second signals IN1 and IN2 have different phases with respect to the first and second transmission durations. The signal phase inverter 170 may be an inverter. In the embodiment, the signal phase inverter 170 is realized as one inverter. However, if needed, the signal phase inverter 170 may be realized as a plurality of inverters. However, the number of the inverters must be an odd number to invert the phase of the second signal IN2.

Since the first and second transmission lines 150, 160A and 160B are formed of metal and there is a dielectric substance, e.g., air, between the first transmission line 150 and the second transmission lines 160A and 1608, a first parasitic capacitance Cl and a second parasitic capacitance C2 are formed between the first and second transmission lines 150, 160A and 160B with the signal phase inverter 170 at the center. In short, the first and second parasitic capacitances C1 and C2 respectively correspond to the first and second transmission durations.

When the first and second signals IN1 and IN2 are transmitted through the first and second transmission lines 150, 160A and 160B, they interfere with each other. This unnecessary coupling is referred to as crosstalk noise. In other words, the first and second signals IN1 and IN2 have a signal delay caused by an effective capacitance existing between the first transmission line 150 and the second transmission lines 160A and 160B, which are positioned adjacent to each other. The signal delay caused by the relatively increased effective capacitance is longer when the first and second signals IN1 and IN2 have the same phase than when the first and second signals IN1 and IN2 have opposite phases.

The signal phase inverter 170 makes the first and second signals IN1 and IN2 have the same phase in any one of the first transmission duration and the second transmission duration and have an opposite phase in the other duration. Therefore, since the entire effective capacitance occurs in the first and second transmission durations regardless of the phases when the first and second signals IN1 and IN2 are inputted, the output skew of the first and second output signals OUT1 and OUT2 outputted by the first and second receivers 130 and 140 is minimized after all.

Hereafter, a method of transmitting a signal in a semiconductor device having the above structure is described in detail with reference to FIG. 4.

FIG. 4 is a timing diagram describing a signal transmitting method of the semiconductor device in accordance with the first embodiment of the present invention. For the sake of convenience in description, FIG. 4 presents one timing diagram obtained by overlapping all cases for the phase relationship between the first signal and the second signal.

Referring to FIG. 4, the first and second signals IN1 and IN2 inputted by the first and second transmitters 110 and 120 may have the same phase or opposite phases. The signal delays of the first and second signals IN1 and IN2 are compensated for during the first and second transmission durations, and the delay-compensated signals, which are the first and second output signals OUT1 and OUT2, are outputted by the first and second receivers 130 and 140.

When the first and second signals IN1 and IN2 inputted by the first and second transmitters 110 and 120 have the same phase, the first and second output signals OUT1 and OUT2 outputted by the first and second receivers 130 and 140 are delayed by a time period ‘AA.’ The signal delay is increased as compared with conventional technology (AA>A). The first and second signals IN1 and IN2 having the same phase maintain the same phase in the portions of the transmission lines 150, 160A, and 160B having the first transmission duration but the signal phase inverter 170 makes the first and second signals IN1 and IN2 have an opposite phase in the portions of the transmission lines 150, 160A, and 160B having the second transmission duration. The first and second signals IN1 and IN2 are subjected to a different effective capacitance caused by the first and second parasitic capacitances C1 and C2 according to the phase relationship thereof, whether the phases are the same or different. When the first and second signals IN1 and IN2 have the same phase, the effective capacitance is decreased. When the first and second signals IN1 and IN2 have opposite phases, the effective capacitance is increased. Therefore, the first and second output signals OUT1 and OUT2 have an increased signal delay, as compared with conventional technology.

When the first and second signals IN1 and IN2 inputted by the first and second transmitters 110 and 120 have different phases, the first and second output signals OUT1 and OUT2 outputted by the first and second receivers 130 and 140 are delayed by a time period ‘BB.’ The signal delay is decreased as compared with conventional technology (BBB). The first and second signals IN1 and IN2 having different phases maintain the different phase during the first transmission duration but the signal phase inverter 170 makes the first and second signals IN1 and IN2 have the same phase during the second transmission duration. The first and second signals IN1 and IN2 are subjected to different effective capacitances according to the phase relationship, whether the phases are the same or different. Therefore, the first and second output signals OUT1 and OUT2 have a decreased signal delay, as compared with conventional technology.

As described above, when the first and second signals IN1 and IN2 are transmitted through the first and second transmission lines 150, 160A and 160B, the signal phase inverter 170 causes the first and second signals IN1 and IN2 to have a different phase relationship for each transmission duration. Therefore, when the first and second signals IN1 and IN2 have the same phase, compensation increases a signal delay. When the first and second signals IN1 and IN2 have opposite phases, compensation decreases a signal delay. Since the output skew of the first and second output signals OUT1 and OUT2, that is, a delay time difference DD, is minimized (DD<D), a high frequency operation may be performed.

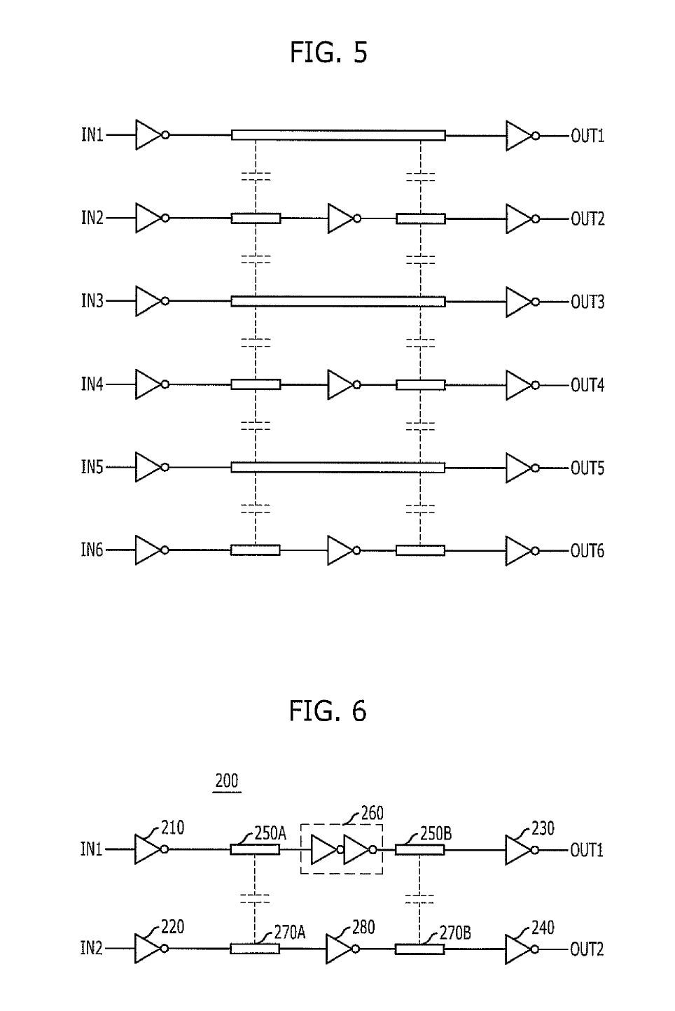

The semiconductor device 100 according to the first embodiment of the present invention may be applied to an extended form as illustrated in FIG. 5. In other words, when the signal phase inverter 170 is added to every transmission line, the output skew caused by crosstalk noise may be minimized when a plurality of signals are simultaneously transmitted. Of course, each signal phase inverter 170 is positioned at the central part of the corresponding transmission lines.

Hereafter, a semiconductor device fabricated according to a second embodiment of the present invention is described with reference to FIG. 6.

FIG. 6 is a schematic diagram illustrating an internal structure of a semiconductor device shown in accordance with a second embodiment of the present invention. Since the second embodiment shows a structure obtained by adding a repeater to the structure of the first embodiment, the same constituent elements as those of the first embodiment are not described.

Referring to FIG. 6, when a load applied to first transmission lines 250A and 250B is large, a repeater 260 is positioned between the first transmission lines 250A and 250B in order to compensate for the large load. The repeater 260 may be realized not to invert the phase of a first signal IN1 when the first signal IN1 is transmitted through the first transmission lines 250A and 250B. In short, the repeater 260 may be realized by an even-number of inverters.

When the repeater 260 is added to the first transmission lines 250A and 250B, too, if a signal phase inverter 280 is formed at the central part of second transmission lines 270A and 270B, the same effect based on the principle described with reference to the first embodiment may occur.

According to the embodiments of the present invention, which are described above, it is possible to minimize the output skew caused by crosstalk noise while not increasing the volume of a semiconductor device and thus enabling a high frequency operation to be performed.

The semiconductor device fabricated according to one of the embodiments of the present invention and a signal transmitting method thereof may have the following effects.

When a first signal and a second signal are transmitted through a first transmission line and a second transmission line which are positioned adjacent to each other, the first and second signals are transmitted to have a first phase relationship during a first transmission duration, and they are transmitted to have a second phase relationship during a second transmission duration.

When the first and second signals are transmitted in this way, the first and second signals have the first and second phase relationships while they are transmitted through the first and second transmission lines, and accordingly, the signal delay characteristics offset each other. Therefore, the output skew caused by crosstalk noise is minimized as compared with conventional technology and thus, high frequency operation can be performed.

Also, since it is not necessary to add transmission lines, such as shielding lines, and only a signal phase inverter is added to the corresponding transmission lines that are formed in advance, the problems associated with an increased volume of the semiconductor device are obviated.

While the present invention has been described with respect to specific embodiments, it will be apparent to those skilled in the art that various changes and modifications may be made without departing from the spirit and scope of the present invention as defined by the following claims.

What is claimed is:

1. A semiconductor device including a plurality of transmission lines for transmitting a plurality of signals, comprising:
a first transmission line configured to transmit a first signal while maintaining a same phase of the first signal during an entire transmission duration; and
a second transmission line positioned adjacent to the first transmission line and configured to transmit a second signal while inverting a phase of the second signal for a first transmission duration of the entire transmission duration.

2. The semiconductor device of claim 1, wherein the first and second signals comprise one of address signals and data signals.

3. A semiconductor device including a plurality of transmission lines for transmitting a plurality of signals, comprising:
a first transmission line configured to transmit a first signal while maintaining a same phase of the first signal during an entire transmission duration; and
a second transmission line positioned adjacent to the first transmission line and configured to transmit a second signal;
a signal phase inverter arranged between portions of the second transmission line having a first transmission duration and a second transmission duration of the entire transmission duration of the second transmission line and configured to invert a phase of the second signal to have opposite phases in the first transmission duration and the second transmission duration.

4. The semiconductor device of claim 3, wherein the signal phase inverter comprises an odd-number of inverters.

5. The semiconductor device of claim 3, wherein the signal phase inverter is arranged at a central portion of the second transmission line.

6. The semiconductor device of claim 3, wherein the first and second signals comprise one of address signals and data signals.

7. A semiconductor device including a plurality of transmission lines for transmitting a plurality of signals, comprising:
a first transmission line configured to transmit a first signal;
a first repeater added to the first transmission line and including an even-number of inverters;
a second transmission line configured to transmit a second signal; and
a second repeater added to the second transmission line and including an odd-number of inverters.

8. The semiconductor device of claim 7, wherein the second repeater is added to a central portion of the second transmission line.

9. The semiconductor device of claim 7, wherein the first and second signals comprise one of address signals and data signals.

10. A method of transmitting a signal in a semiconductor device which respectively transmits a first signal and a second signal through first and second transmission lines arrayed adjacent to each other, the method comprising:
transmitting the first signal and the second signal to have a first phase relationship in a first transmission duration of the first transmission line and the second transmission line; and
transmitting the first signal and the second signal to have a second phase relationship in a second transmission duration of the first transmission line and the second transmission line, wherein the second phase relationship is opposite to the first phase relationship.

11. The method of claim 10, wherein the first and second signals are transmitted in a phase relationship of the same phase in the first transmission line.

12. The method of claim 10, wherein the first and second signals are transmitted in a phase relationship of opposite phases in the first transmission line.
